(19) United States
(12) Patent Application Publication
(10) Pub. No.: US 2009/0000178 A1
(43) Pub. Date: Jan. 1, 2009

(54) Pollywog lures

(76) Inventor: William Seniker, Bunker Hill, IL (US)

Correspondence Address: JAMES RAY & ASSOCIATES, 2640 PITCAIRN ROAD, MONROEVILLE, PA, 15146, US

(21) Appl. No.: 12/214,436

(22) Filed: Jun. 19, 2008

Related U.S. Application Data
(60) Provisional application No. 60/946,603, filed on Jun. 27, 2007.

(51) Int. Cl. A01K 85/00

(52) U.S. Cl. 43/42.28; 43/42.42

(57) ABSTRACT

A fishing lure for use in fishing for wide mouth bass and similar species of fish. The fishing lure comprises a tadpole shaped lure having each of a predetermined color and a predetermined length and formed of a predetermined material. There is an extended tail member disposed on a back portion of the tadpole shaped fishing lure. At least one hook extends downward from a predetermined portion of the tadpole shaped lure. Such at least one hook is for lodging itself in a fish when such fish bites on the tadpole shaped lure. There is, further, a circular attachment disposed on a front portion of the tadpole shaped lure for attaching such tadpole shaped lure to a fishing line.

### CROSS REFERENCE TO RELATED APPLICATIONS

This application is closely related to and claims benefit from U.S. Provisional Application Ser. No. 60/946,603 filed Jun. 27, 2007.

### FIELD OF THE INVENTION

The present invention relates, in general, to a fishing lure, and, more particularly the present invention relates to a fishing lure that is shaped and colored so as to look like a tadpole.

### BACKGROUND OF THE INVENTION

Fishing can be a challenging and rewarding sport. Any advantage the fisherman can obtain over the fish is generally welcomed. Generally, all fisherman start out as bait fishermen. It seems only logical to use a natural live bait to catch fish. After the fisherman gets good at taking fish on live bait he will start thinking of sports fishing and the use of artificial lures. Artificial lures come in a wide variety of shapes and sizes and is basically dependent on the type of fish one is fishing for.

Traditional tadpole shaped lures don't offer the maneuverability that many anglers desire, and other types of live bait can be messy and ineffective.

Thus, it would be advantageous if there were an artificial lure that could excel in helping the fisherman in catching the fish of choice, for example large mouth bass and similar species.

### SUMMARY OF THE INVENTION

In a first aspect the present invention provides a fishing lure for use in fishing for wide mouth bass and similar species of fish. The fishing lure comprises a tadpole shaped lure having each of a predetermined color and a predetermined length and formed of a predetermined material. There is an extended tail member disposed on a back portion of the tadpole shaped fishing lure. At least one hook extends downward from a predetermined portion of the tadpole shaped lure. Such at least one hook is for lodging itself in a fish when such fish bites on the tadpole shaped lure. There is, further, a means disposed on a front portion of the tadpole shaped lure for attaching such tadpole shaped lure to a fishing line.

### OBJECTS OF THE INVENTION

It is, therefore, one of the primary objects of the present invention to provide a fishing lure that is especially useful in catching wide mouth bass and similar species.

Another object of the present invention is to provide a fishing lure that is shaped like a tadpole.

Still another object of the present invention is to provide a fishing lure that comes in a variety of colors.

Yet another object of the present invention is to provide a fishing lure that has double hooks disposed therein that lodge themselves into the fish.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a top view of the tadpole fishing lure according to an embodiment of the invention.

FIG. 2 is a is a side perspective view of the tadpole fishing lure shown in FIG. 1 showing the filmy tail and the double hooks and wires.

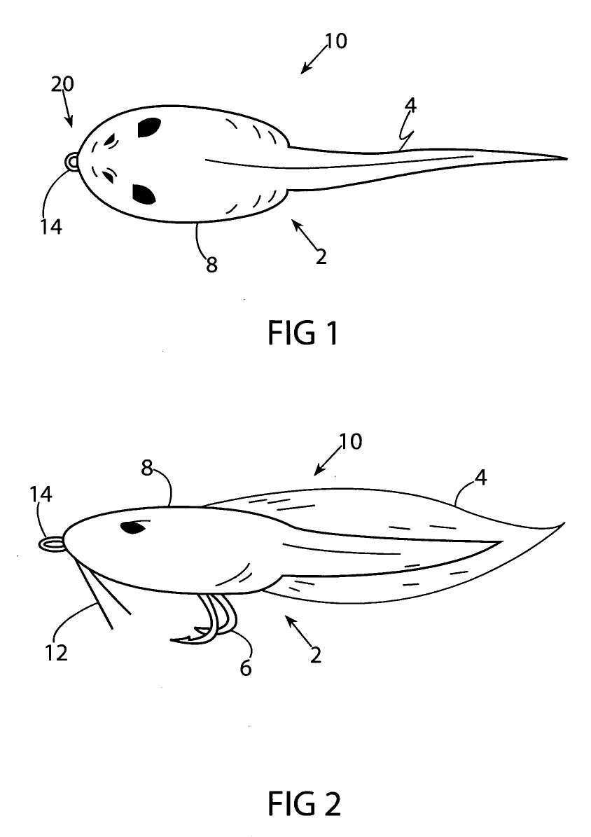

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides a fishing lure for use in fishing for wide mouth bass and similar species of fish. The fishing lure, generally designated 10, comprises a tadpole shaped lure 2 having each of a predetermined color and a predetermined length and formed of a predetermined material. There is an extended tail member 4 disposed on a back portion of the tadpole shaped fishing lure 2. At least one hook 6 extends downward from a predetermined portion of the tadpole shaped lure 2. Such at least one hook 6 is for lodging itself in a fish when such fish bites on the tadpole shaped lure 2. There is, further, a means, generally designated 20, disposed on a front portion of the tadpole shaped lure 2 for attaching such tadpole shaped lure 21 to a fishing line.

It is presently preferred that there are two hooks 6 disposed closely adjacent a back part on an underside of the body portion 8 of the tadpole shaped fishing lure 2.

It is also preferred that such tail member 4 has a substantially solid central portion and a filmy portion disposed on each side of substantially solid central portion. It is also preferred that such predetermined material for forming such fishing lure 10 is plastic.

The predetermined length of the tadpole shaped lure 2 is between about 2¾ inches and about 3¼ inches in length. And it is also preferred that such tail portion 4 of the tadpole shaped lure 2 comprises more than one half of the predetermined length of the tadpole shaped lure 2. This makes it look more authentic and more like the real thing to such fish. The predetermined color of the fishing lure 10 is selected from one of red, yellow, green and brown.

It is also within the scope of the invention that such tadpole shaped lure 2 includes a pair of wires 12 disposed on a front underside portion of tadpole shaped lure 2 and extending rearward for helping in preventing weeds from collecting on the tadpole shaped lure 2. Such wires 12 are flexible and extend rearward toward the hooks 6 and deflect weeds thereby keeping the hooks free for catching such fish that bites on the lure 10.

Such means 20 for attaching the tadpole shaped lure 2 to a fishing line includes a circular shaped attachment 14 disposed on a front portion of the lure 10.

Thus, the present invention provides a tadpole (pollywog) shaped fishing lure used to catch large-mouth bass or similar fish that feed on tadpoles. The basic shape of the tadpole is maintained but instead of legs the pollywog has double hooks which are used to catch the fish when it bites on the tadpole. Two wires can be added to the top of the tadpole lure to help make the lure weedless. The pollywog is substantially 3 inches long and is designed with a variety of colors, such as red, yellow, green and brown. It is within the scope of the invention that the size of the tadpole shaped lure could be different and also be made in different colors to adapt to both the fish and the fisherman's preference. The tadpole lure is basically designed to float on the surface of the water but it can be made to submerse in the water. When the fish bite the lure, the double hooks will lodge themselves into the mouth of the fish. These pollywog lures offer a fresh alternative to the available lures and offer a more realistic looking and controlled lure for every kind of angler. Further, the larger tail on the pollywog gives the design more flexibility and moving action than any tadpole lure on the market making it seem more realistic to the fish.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. A fishing lure for use in fishing for wide mouth bass and similar species of fish, said fishing lure comprising:
(a) a tadpole shaped lure having each of a predetermined color and a predetermined length and formed of a predetermined material;(b) an extended tail member disposed on a back portion of said tadpole shaped fishing lure;
(c) at least one hook extending downward from a predetermined portion of said tadpole shaped lure, said at least one hook for lodging itself in a fish when such fish bites on said tadpole shaped fishing lure; and
(d) a means disposed on a front portion of said tadpole shaped lure for attaching said tadpole shaped lure to a fishing line.

2. A fishing lure, according to claim 1, wherein said fishing lure has two hooks disposed closely adjacent a back part on an underside of a body portion of said tadpole shaped fishing lure.

3. A fishing lure, according to claim 1, wherein said tail member has a substantially solid central portion and a filmy portion disposed on each side of said substantially solid central portion.

4. A fishing lure, according to claim 1, wherein said predetermined material is plastic.

5. A fishing lure, according to claim 1, wherein said predetermined length of said lure is between about 2¾ inches and about 3¼ inches in length.

6. A fishing lure, according to claim 5, wherein said tail portion of said tadpole shaped lure comprises more than one half of said predetermined length of said lure.

7. A fishing lure, according to claim 1, wherein said predetermined color is selected from one of red, yellow, green and brown.

8. A fishing lure, according to claim 1, wherein said tadpole shaped lure further includes a pair of wires disposed on a front portion of said tadpole shaped lure for helping in preventing weeds from collecting on said lure.

9. A fishing lure, according to claim 1, wherein said means for attaching said tadpole shaped lure to a fishing line includes a circular shaped attachment disposed on a front portion of said lure.
